(19) United States
(12) Patent Application Publication
(10) Pub. No.: US 2016/0343180 A1
(43) Pub. Date: Nov. 24, 2016

(54) AUTOMOBILES, DIAGNOSTIC SYSTEMS, AND METHODS FOR GENERATING DIAGNOSTIC DATA FOR AUTOMOBILES

(71) Applicant: GM GLOBAL TECHNOLOGY OPERATIONS LLC, Detroit, MI (US)

(72) Inventors: GAURAV TALWAR, NOVI, MI (US); XUFANG ZHAO, WINDSOR (CA); MD FOEZUR RAHMAN CHOWDHURY, TROY, MI (US)

(21) Appl. No.: 14/716,630

(22) Filed: May 19, 2015

(51) Int. Cl. G07C 5/08; G01M 17/007; G07C 5/02; G01H 17/00

(52) U.S. Cl. CPC G07C 5/0808; G01H 17/00; G01M 17/007; G07C 5/02

(57) ABSTRACT

Automobiles, automobile diagnostic systems, and methods for generating diagnostic data for automobiles are provided. A method for generating diagnostic data for an automobile includes capturing with a sound sensor an acoustic waveform produced by an automobile component. The method converts the acoustic waveform into an electrical waveform data signal. The method includes identifying a pattern in the electrical waveform data signal. Further, the method classifies the pattern as indicative of a selected performance issue.

### TECHNICAL FIELD

The technical field generally relates to automobile diagnostics, and more particularly relates to diagnosing automobile performance issues through non-voice sound capture.

### BACKGROUND

The Environmental Protection Agency (EPA) required vehicle manufacturers to install on-board diagnostics (OBD-II) for monitoring light-duty automobiles and trucks beginning with model year 1996. OBD-II systems (e.g., microcontrollers and sensors) monitor the vehicle's electrical and mechanical systems and generate data that are processed by a vehicle's engine control unit (ECU) to detect any malfunction or deterioration in the vehicle's performance. Most ECUs transmit status and diagnostic information over a shared, standardized electronic bus in the vehicle. The bus effectively functions as an on-board computer network with many processors, each of which transmits and receives data. The primary computers in this network are the vehicle's electronic-control module (ECM) and power-control module (PCM). The ECM typically monitors engine functions (e.g., the cruise-control module, spark controller, and exhaust/gas recirculator), while the PCM monitors the vehicle's power train (e.g., its engine, transmission, and braking systems). Data available from the ECM and PCM include vehicle speed, fuel level, engine temperature, and intake manifold pressure. In addition, in response to input data, the ECU also generates 5-digit ‘diagnostic trouble codes’ (DTCs) that indicate a specific problem with the vehicle. The presence of a DTC in the memory of a vehicle's ECU typically results in illumination of the ‘Service Engine Soon’ light present on the dashboard of most vehicles.

Data from the above-mentioned systems are made available through a standardized connector referred to herein as an ‘OBD-II connector’. The OBD-II connector typically lies underneath the vehicle's dashboard. When a vehicle is serviced, data from the vehicle's ECM and/or PCM is typically queried using an external engine-diagnostic tool (commonly called a ‘scan tool’) that plugs into the OBD-II connector. The vehicle's engine is turned on and data are transferred from the engine computer, through the OBD-II connector, and to the scan tool. The data are then displayed and analyzed to service the vehicle. Scan tools are typically only used to diagnose stationary vehicles or vehicles running on a dynamometer.

Some vehicle manufacturers also include complex electronic systems in their vehicles to access and analyze some of the above-described data. For example, General Motors includes a system called ‘On-Star’ in certain vehicles. On-Star collects and transmits data relating to these DTCs through a wireless network. On-Star systems are not connected through the OBD-II connector, but instead are wired directly to the vehicle's electronic system. This wiring process typically takes place when the vehicle is manufactured.

While the above-noted systems may work well in identifying automotive performance issues, improvement is possible. Further, performance issues for functions outside of engine functions (e.g., the cruise-control module, spark controller, and exhaust/gas recirculator) and power train functions (e.g., the engine, transmission, and braking systems) may not be identified by existing systems.

Accordingly, it is desirable to provide improved automobile diagnostic systems and automobiles with such improved diagnostic systems. In addition, it is desirable to provide improved methods for generating diagnostic data for automobiles. Furthermore, other desirable features and characteristics will become apparent from the subsequent detailed description and the appended claims, taken in conjunction with the accompanying drawings and the foregoing technical field and background.

### SUMMARY

A method for generating diagnostic data for an automobile apparatus is provided. In one embodiment, the method includes capturing with a sound sensor an acoustic waveform produced by an automobile component. The method converts the acoustic waveform into an electrical waveform data signal. The method includes identifying a pattern in the electrical waveform data signal. Further, the method classifies the pattern as indicative of a selected performance issue.

An automobile diagnostic system is provided. In one embodiment, an automobile diagnostic system includes a sound sensor coupled to an automobile for receiving a non-speech sound. Further, the exemplary automobile diagnostic system includes a processor including a conversion module for converting the non-speech sound to an electrical waveform data signal, and a classification module for classifying the electrical waveform data signal as indicative of a selected performance issue.

In another embodiment, an automobile is provided. The automobile includes a frame, a sound sensor coupled to the frame for receiving a non-speech sound, and a processor. The processor includes a conversion module for converting the non-speech sound to an electrical waveform data signal. The processor further includes a classification module for classifying the electrical waveform data signal as indicative of a selected performance issue.

### DESCRIPTION OF THE DRAWINGS

The embodiments will hereinafter be described in conjunction with the following drawing figures, wherein like numerals denote like elements, and wherein:

FIG. 1 is a schematic view of an automobile in accordance with an embodiment;

FIG. 2 is a schematic view of the diagnostic system 20 of FIG. 1 in accordance with an embodiment; and

FIG. 3 is a flow chart illustrating an example of a method for generating diagnostic data for an automobile in accordance with an embodiment.

### DETAILED DESCRIPTION

The following detailed description is merely exemplary in nature and is not intended to limit the application and uses of embodiments described herein. Furthermore, there is no intention to be bound by any expressed or implied theory presented in the preceding technical field, background, brief summary or the following detailed description.

The following description refers to elements or features being “connected” or “coupled” together. As used herein, “connected” may refer to one element/feature being mechanically joined to (or directly communicating with) another element/feature, and not necessarily directly. Likewise, “coupled” may refer to one element/feature being directly or indirectly joined to (or directly or indirectly communicating with) another element/feature, and not necessarily mechanically. However, it should be understood that although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

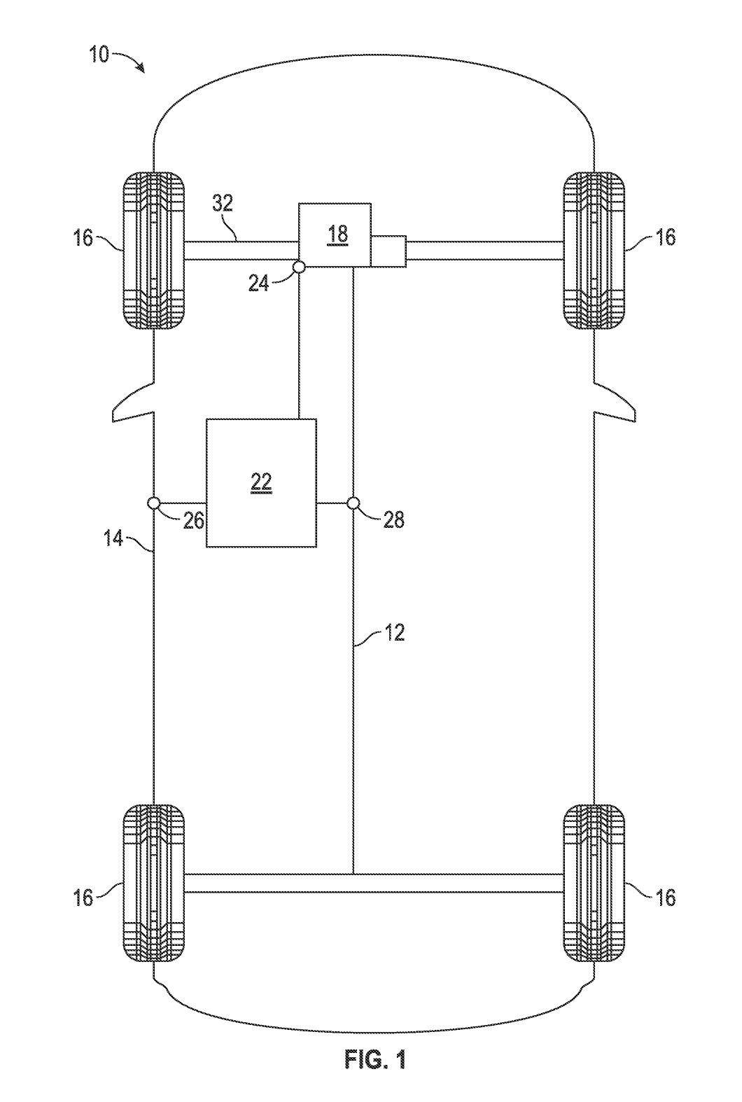

Further, various components and features described herein may be referred to using particular numerical descriptors, such as first, second, third, etc., as well as positional and/or angular descriptors, such as horizontal and vertical. However, such descriptors may be used solely for descriptive purposes relating to drawings and should not be construed as limiting, as the various components may be rearranged in other embodiments. It should also be understood that FIGS. 1-3 are merely illustrative and may not be drawn to scale.

FIG. 1 illustrates a vehicle (or “automobile”) 10 provided with a diagnostic system 20, according to one embodiment herein. The automobile 10 includes a chassis 12, a body 14, four wheels 16, and an electronic control system 18. The body 14 is arranged on the chassis 12 and substantially encloses the other components of the automobile 10. The body 14 and the chassis 12 may jointly form a frame. The wheels 16 are each rotationally coupled to the chassis 12 near a respective corner of the body 14.

The automobile 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD), or all-wheel drive (AWD). The automobile 10 may also incorporate any one of, or combination of, a number of different types of engines, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine (i.e., such as in a hybrid electric vehicle (HEV)), and an electric motor.

In the exemplary embodiment illustrated in FIG. 1, the automobile 10 includes a combustion engine and/or an electric motor/generator 18. The combustion engine and/or the electric motor 28 may be integrated such that one or both are mechanically coupled to at least some of the wheels 16 through one or more drive shafts 32. In one embodiment, the automobile 10 is a “series HEV,” in which the combustion engine is not directly coupled to the transmission, but coupled to a generator (not shown), which is used to power the electric motor. In another embodiment, the automobile 10 is a “parallel HEV,” in which the combustion engine is directly coupled to the transmission by, for example, having the rotor of the electric motor rotationally coupled to the drive shaft of the combustion engine.

Further, the automobile 10 includes a diagnostic system 20 for diagnosing performance issues from non-voice sounds. As shown, the diagnostic system 20 includes a processor 22. The processor 22 is coupled to sound sensors 24, 26 and 28.

Sound sensors 24, 26 and 28 may be micro-electro-mechanical system (MEMS) based directional sound sensors, i.e., microphones formed as solid state integrated circuits, or other sound sensing instruments. Sound sensor 24 is embedded in, or otherwise fixed to, the combustion engine/electric motor/generator 18. Sound sensor 26 is embedded in, or otherwise fixed to, the body 14. Sound sensor 28 is embedded in, or otherwise fixed to, the chassis 12. While three sound sensors are illustrated, the diagnostic system 20 may include one, two, three, or more sound sensors for receiving external sounds, i.e., sounds originating outside of the automobile cabin.

Although not shown in detail in FIG. 1, the processor 22 includes various modules for receiving and converting sounds or acoustic waveforms into electrical waveforms, and for processing electrical waveform data signals such as identifying patterns in the electrical waveform data signals and classifying patterns as indicative of selected performance issues. Further, the processor 22 may include or be in communication with memory for storing libraries of healthy vehicle sound distribution patterns and of patterns associated with known performance issues.

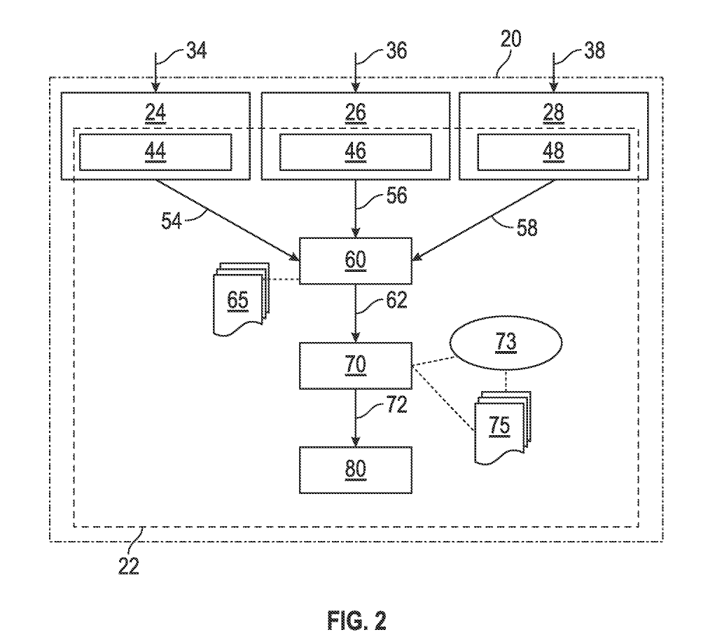

FIG. 2 illustrates the various modules and processing performed by the processor 22. As shown, external, non-voice sounds 34, 36, and 38 are received by the sensors 24, 26, and 28, respectively. As noted above, the diagnostic system 20 may include fewer or more sensors than the three illustrated. Accordingly, one sound or many sounds may be processed by the diagnostic system 20. While three sounds 34, 36 and 38 are processed in FIG. 2, embodiments herein neither require nor are limited to capturing and processing sounds at three sound sensors.

Each sound 34, 36, and 38 may be characterized as an acoustic waveform or audio signature. Sounds 34, 36, and 38 may be produced by a same source or sources but may have different characteristics or properties as received by the sensors 24, 26, and 28 due to the differing locations of the sensors 24, 26, and 28. For example, sound 34 may include a higher volume or amplitude of noise originating from the engine 18 while sound 26 may include a higher volume or amplitude of noise originating from tire 16. Further, sounds 34, 36, and 38 may include differing levels of ambient noise based on their location.

As shown, conversion modules 44, 46, and 48 are provided in the diagnostic system 20 to convert the sounds 34, 36 and 38 into electrical waveform data signals 54, 56 and 58. As shown, the conversion modules 44, 46 and 48 may be part of sensors 24, 26 and 28 and/or part of processor 22. Further, while FIG. 2 illustrates separate conversion modules 44, 46, and 48 dedicated for each sound sensor 24, 26, and 28, a single conversion module may be provided to convert sounds into data signals for all, or a portion, of the sensors.

In FIG. 2 independent and separate electrical waveform data signals 54, 56, and 58 are produced by the conversion modules 44, 46, and 48. Alternatively, a single combined electrical waveform data signal may be produced by a conversion module or the conversion modules. In either case, the electrical waveform data signal or signals 54, 56, and 58 are communicated to an identification module 60. The identification module 60 is adapted to identify a pattern 62 in the electrical waveform data signal or signals 54, 56, and 58. For example, the electrical waveform data signal may comprise a distribution, such as a Gaussian distribution exhibited by normal engine operation. Additionally, the electrical waveform data signal may include an outlier or outliers to the normal distribution. Such outlier or outliers may form a pattern. As shown, the identification module 60 may communicate with memory 65, such as a library of healthy vehicle sound distribution patterns. Thus, the identification module can identify any pattern or patterns 62 that are not exhibited by healthy vehicles, i.e., pattern or patterns of interest 62 for further analysis. Further, the identification module 60 may analyze the amplitude or other properties of the pattern or patterns of interest 62. For example, a Fast Fourier Transform can provide analysis of energy and/or phase difference. Also, energy averages and variances across audio frames can be analyzed. Mel Frequency Cepstral Coefficients can be analyzed, such as by a pattern classifier such as Gaussian Mixture Models, K-means algorithms, neural networks, Bayesian Classifiers, and the like. If the amplitude or other property of the pattern or patterns of interest 62 does not exceed a threshold value, the identification module may indicate no further processing is necessary. Alternatively, the identification module 60 may determine whether the pattern or patterns of interest 62 are within a confidence threshold. Mel Cepstrum Frequency Coefficients are believed to be appropriate for classifying most vehicle diagnostic or mechanical issue related noises.

The confidence threshold is based on probability or likelihood. In an exemplary approach, an electrical waveform data signal is assigned to a predefined class or category that provides highest probability or maximum likelihood, i.e., the signal is paired to a pattern indicative of a predetermined category of performance issue. In doing so, the probability may be calculated for each predefined category, such as, for example road noise, engine noise, poor suspension, squeaky brakes. The results may be queued in order of descending order of probability. The aforementioned features could be used to evaluate the maximum likelihood that the electrical waveform data signal fits each predefined category. Each audio category will have a unique signature in terms of aforementioned audio features or properties. For example, the confidence threshold may be tuned to less than 1% false acceptance. In this process, the sequence of audio spectrum or energy spectrum in each time frame can serve as feature vector. This feature vector from the test audio sample may be used in conjunction with the predefined audio categories to compute a likelihood or confidence score. For each category, there may be a corresponding likelihood score and the probably categories may be ranked in order of these scores.

If the identified pattern or patterns of interest 62 do meet the threshold value, the identification module 60 may communicate the identified pattern or patterns of interest 62 to a classification module 70. The classification module 70 is adapted to classify the pattern 62 as indicative of a selected performance issue. Diagnostic data including the selected performance issue 72 and, optionally, recommendations for corrective action may be created by the classification module 70. For pattern classification, during the first phase, the system may be trained to classify each labeled audio sample by using input features iteratively and in recursive fashion to reduce the classification error for known audio samples (already labeled). After the system has satisfactory classification performance with known set of data then it may be used for classifying the audio samples with unknown categories. The vehicle manufacturer may collect audio samples during the vehicle development and validation phases like a low tread tire could be deployed and corresponding audio signature could be recorded for training purposes.

In classifying the pattern 62, the classification module 70 may use a probability model 73 stored in memory of the processor 22. For example, the probability model 73 may be selected from the group consisting of Bayesian network models, dynamic Bayesian network models, hidden Markov models, fuzzy logic models, neural network models and Petri net models. Such models may use multiple regression, Bayesian probability criterion, or probability observations/models. The feature effectiveness techniques may assist in selecting features that are conducive to classification. After selection of features based on complexity of the algorithm and processing power (MIPS) available of the CPU (Microcontroller), an appropriate pattern classifier could be used. For example, Neural Networks may outperform Bayesian Classifiers. However, the former may require more computation and processing overhead. As explained earlier, each feature vector shall be provided a probability score for the event that it pertains to a particular audio category. The feature vector with the highest score may be assigned as the label of the test audio.

Further, the classification module 70 and probability model 73 may be in communication with a memory 75, such as a library of patterns associated with known performance issues. For example, the library of patterns may be associated with performance issues such as low tire tread, low brake drums/pads, timing belt issues, transmission issues, suspension issues, and/or exhaust issues, among other causes for performance issues. Classification of the pattern 62 may include comparing the pattern to patterns within the library 75 that are associated with known performance issues. A multitude of features are available for comparison. However, the effectiveness of comparison for specific features may be measured by techniques such as principal component analysis or factor analysis or discriminant analysis. A correlation study may indicate which feature is more effective in classifying various vehicle mechanical noises, such as, for example, one originating from low tire tread noise.

The classification module 70 may communicate the diagnostic data including the selected performance issue 72 to a diagnostic module 80 that may be part of or outside of the processor 20. For example, the diagnostic module 80 may include a display light or other messaging to the automobile operator indicating a need for maintenance. Alternatively or additionally, the diagnostic module 80 may prepare for communication to an automotive technician upon service of the automobile. Further, the diagnostic data including the selected performance issue 72 may be added to the data from the vehicle's ECM and/or PCM stored in the OBD-II connector for querying by the external engine-diagnostic tool.

In an embodiment, the library 65 of healthy vehicle sound distribution patterns may be created through the accumulation of audio data, i.e., sounds, during test driving of an automobile fitted with sensors 24, 26 and 28 at a variety of speeds in a variety of weather conditions and over a variety of road surfaces, e.g., grooved pavement, concrete, asphalt, gravel, sand, dirt, etc., and environments, e.g., heavy traffic, open areas, forests, tunnels, bridges, etc. Optionally, the diagnostic system 20 may be designed to continue to learn healthy vehicle sound distribution patterns while driven by the end user.

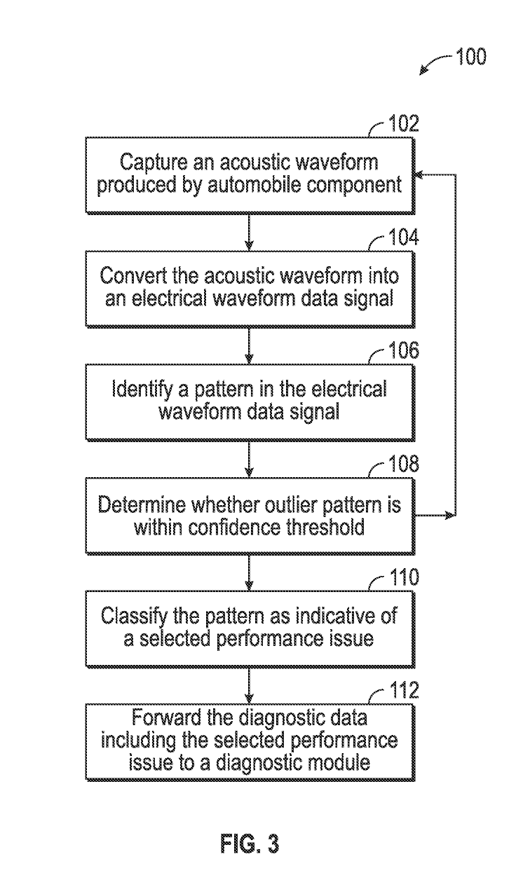

FIG. 3 illustrates an embodiment of a method for generating diagnostic data for an automobile. The method 100 includes capturing an acoustic waveform produced by an automobile component at block 102. For example, a sound sensor or a plurality of sound sensors embedded in structural components of the automobile may be used to receive ambient noise. The method converts the acoustic waveform into an electrical waveform data signal at block 104. Independent and separate electrical waveform data signals may be produced for each sensor, or a single combined electrical waveform data signal may be produced for all sensors or for selected sensors.

At block 106, the method includes identifying a pattern in the electrical waveform data signal. The method may identify a pattern in the electrical waveform data signal by comparing the pattern in the electrical waveform data signal to a healthy vehicle sound distribution pattern or to a library of healthy vehicle sound distribution patterns. Through comparing the pattern to the healthy vehicle sound distribution pattern or patterns, the method may identify an outlier pattern unique to the electrical waveform data signal.

At block 108, the method determines whether the outlier pattern is within a confidence threshold. If the outlier pattern is not within the confidence threshold, the method continues at block 102 with further capture of acoustic waveforms. If the outlier pattern is within the confidence threshold, then at block 110 the outlier pattern is categorized as a pattern of interest or indicative of a selected performance issue. For example, the method may classify the pattern using a probability model selected from the group consisting of Bayesian network models, dynamic Bayesian network models, hidden Markov models, fuzzy logic models, neural network models and Petri net models. Further, the method may compare the pattern to a library of patterns associated with known performance issues, wherein the known performance issues include low tire tread, low brake drums/pads, timing belt issues, transmission issues, suspension issues, and/or exhaust issues. The method continues at block 112 with forwarding the diagnostic data including the selected performance issue to a diagnostic module.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof

What is claimed is:

1. A method for generating diagnostic data for an automobile, the method comprising:
capturing with a sound sensor an acoustic waveform produced by an automobile component;
converting the acoustic waveform into an electrical waveform data signal;
identifying a pattern in the electrical waveform data signal; and
classifying the pattern as indicative of a selected performance issue.

2. The method of claim 1 further comprising forwarding the diagnostic data including the selected performance issue to a diagnostic module.

3. The method of claim 1 wherein identifying a pattern in the electrical waveform data signal comprises:
comparing the pattern in the electrical waveform data signal to a healthy vehicle sound distribution pattern; and
identifying an outlier pattern unique to the electrical waveform data signal.

4. The method of claim 1 wherein the processor includes a library of healthy vehicle sound distribution patterns, wherein identifying a pattern in the electrical waveform data signal comprises:
comparing the pattern in the electrical waveform data signal to the library of healthy vehicle sound distribution patterns; and
identifying an outlier pattern unique to the electrical waveform data signal.

5. The method of claim 1 wherein identifying a pattern in the electrical waveform data signal comprises:
comparing the pattern in the electrical waveform data signal to a healthy vehicle sound distribution pattern;
identifying an outlier pattern unique to the electrical waveform data signal;
determining whether the outlier pattern is within a confidence threshold;
if the outlier pattern is within the confidence threshold, categorizing the outlier pattern as a pattern of interest, wherein classifying the pattern as indicative of a selected performance issue comprises classifying the pattern of interest as indicative of a selected performance issue.

6. The method of claim 1 wherein classifying the pattern as indicative of a selected performance issue comprises classifying the pattern using a probability model selected from the group consisting of Bayesian network models, dynamic Bayesian network models, hidden Markov models, fuzzy logic models, neural network models and Petri net models.

7. The method of claim 1 wherein classifying the pattern as indicative of a selected performance issue comprises comparing the pattern to a library of patterns associated with known performance issues, wherein the known performance issues include low tire tread, low brake drums/pads, timing belt issues, transmission issues, suspension issues, and/or exhaust issues.

8. The method of claim 1 wherein classifying the pattern as indicative of a selected performance issue comprises comparing the pattern to a library of patterns associated with known performance issues.

9. The method of claim 1 wherein capturing a sound waveform produced by an automobile component with a sound sensor comprises receiving ambient noise with a plurality of sound sensors.

10. The method of claim 1 wherein capturing a sound waveform produced by an automobile component with a sound sensor comprises receiving ambient noise with a plurality of sound sensors embedded in structure components of the automobile.

11. An automobile diagnostic system comprising:
a sound sensor coupled to an automobile for receiving a non-speech sound; and
a processor including a conversion module for converting the non-speech sound to an electrical waveform data signal, and a classification module for classifying the electrical waveform data signal as indicative of a selected performance issue.

12. The automobile diagnostic system of claim 11 wherein the processor includes an identification module for identifying a pattern in the electrical waveform data signal, wherein the classification module classifies the pattern as indicative of a selected performance issue.

13. The automobile diagnostic system of claim 12 wherein the processor includes a memory adapted to store a library of healthy vehicle sound distribution patterns, wherein the identification module is adapted to communicate with the library to compare the pattern in the electrical waveform data signal to the healthy vehicle sound distribution patterns and to identify an outlier pattern unique to the electrical waveform data signal.

14. The automobile diagnostic system of claim 12 wherein the processor includes a memory adapted to store a library of patterns associated with known performance issues, and wherein the classification module is adapted to communicate with the library to classify the pattern as indicative of a selected performance issue based on the library of patterns associated with known performance issues.

15. The automobile diagnostic system of claim 12 wherein the processor includes a memory adapted to store a library of patterns associated with known performance issues including low tire tread, low brake drums/pads, timing belt issues, transmission issues, suspension issues, and/or exhaust issues; and wherein the classification module is adapted to communicate with the library to classify the pattern as indicative of a selected performance issue based on the library of patterns associated with known performance issues.

16. The automobile diagnostic system of claim 11 further comprising an output display for communicating the selected performance issue.

17. An automobile comprising:
a frame;
a sound sensor coupled to the frame for receiving a non-speech sound; and
a processor including a conversion module for converting the non-speech sound to an electrical waveform data signal and a classification module for classifying the electrical waveform data signal as indicative of a selected performance issue.

18. The automobile of claim 17 wherein the processor includes an identification module for identifying a pattern in the electrical waveform data signal, wherein the classification module classifies the pattern as indicative of a selected performance issue.

19. The automobile of claim 17 wherein the sound sensor is a frame sound sensor, and wherein the automobile further comprises:
an engine;
an engine sound sensor coupled to the engine for receiving a non-speech sound, wherein the conversion module is adapted to convert the non-speech sound from the frame sound sensor and from the engine sound sensor to electrical waveform data signals.

20. The automobile of claim 17 further comprising an output display for communicating the selected performance issue.
